(19) United States
(12) Patent Application Publication
(10) Pub. No.: US 2008/0301581 A1
(43) Pub. Date: Dec. 4, 2008

(54) METHOD AND SYSTEM FOR PROVIDING ADDITIONAL INFORMATION SERVICE ONTO E-MAIL

(75) Inventors: Chang Yol Baek, Seoul (KR); Jee Sook Lee, Seongnam-si (KR); Han Byeol Choi, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, Seongnam-si (KR)

(21) Appl. No.: 12/131,709

(22) Filed: Jun. 2, 2008

(30) Foreign Application Priority Data
Jun. 1, 2007 (KR) 10-2007-0054052

(51) Int. Cl. G06F 3/048

(52) U.S. Cl. 715/810

(57) ABSTRACT

A method of providing dynamic services for web applications, such as e-mail, is disclosed. When a user selects text or an item, the selection is analyzed for the presence of various formats or patterns. For example, the items selected or highlighted by the user may be identified as a name, an address, a date, a location, etc. Based on the formats or patterns, various connection functions may then be provided to the user. The connection functions may be provided in the form of various menus, such as a context menu, a right-click menu, a pop-up window, and the like. In addition, the entries of the menu may be dynamically maintained depending on the nature of the items' formats or patterns.

### CROSS-REFERENCE TO RELATED APPLICATIONS

This application claims the benefit of Korean Patent Application No. 10-2007-0054052, filed on Jun. 1, 2007, which is hereby incorporated by reference in its entirety.

### BACKGROUND OF THE DISCLOSURE

1. Field of the Disclosure

The present disclosure relates to a method and system for providing additional information service related with e-mails.

2. Description of the Related Art

Currently, with the proliferation of networks like the Internet, online and web applications have become widespread. A web application is any application that can be accessed from a server via a web browser or some application that supports web languages. Web applications are popular because many computing platforms, such as personal computers, laptops, mobile phones, etc., are capable of providing a web-compatible interface, such as a browser. For example, web applications, such as e-mail and search engines, are well known. These web applications are useful to access content from the Internet, which can vary from news, search, shopping, video and photo, audio, mapping, and so forth.

### SUMMARY OF THE DISCLOSURE

Embodiments of the present disclosure provide methods and systems for accessing information services, such as web applications and applications running locally on a terminal. For example, when a user sets a block of, selects, or highlights information in an e-mail, the user can quickly perform desired work with a connection function that is provided based on an analysis of the pattern or format of the selected information. In an embodiment, various connection functions may be provided in a menu, such as context menu or pop-up type menu. In an embodiment, the user can manipulate the information they have selected and may also be automatically provided useful additional information that is related to the selected information. In an embodiment, as the user selects or highlights information, an analysis of this information may be integrally provided and related additional useful information may be provided in addition to basic editing functions.

An aspect of the present disclosure relates to a method of providing an additional information service onto an e-mail, which comprises providing predetermined basic information to a user terminal, receiving from the user terminal a message indicating that at least a portion of the predetermined basic information has been set by a block, selected, or highlighted, analyzing the pattern of the selected information to determine one or more connection functions according to the analyzed pattern, and transmitting a message for executing the one or more connection functions to the user terminal.

The predetermined basic information may be an e-mail or a web document, and contents of the predetermined basic information may comprise text information, image information, sound information, or multimedia information. The transmitting of the message may include function menu data for allowing the user to select the one or more connection functions at the user terminal and transmitting based on a selection by the user.

In an embodiment, the connection function menu is automatically outputted to the user terminal when the selection of text by the user is completed or while the user is selecting or highlighting text. The connection function menu may be a menu, such as a context menu, or pop-up type menu or window and the connection function menu may disappear after waiting for a user selection for a predetermined period of time.

The connection functions that may be provided can include one or more basic functions commonly applied regardless of the pattern of the selected information, such as cut, copy, paste, etc. The functions can include other functions, such as, a function for copying the selected information without the format, transmitting the information in a new e-mail, transmitting the information by a SMS, and transmitting the information by a desktop memo or word processor.

The information selected or highlighted by the user may be analyzed for various formats and patterns. These patterns or formats may be selected from a set of predetermined patterns or formats. For example, if the selected information consists of adjacent numbers of at least a predetermined length, the selected information may be identified as a phone number. When the selected information is identified as a phone number pattern, the connection functions can include a phone-calling function or an address-registration function.

As another example, if the selected information consists of a sequence of consecutive letters, the selected information may be identified as a name of a person, place, thing, etc. When the selected information is identified as a name of a person, place, or thing, the connections functions can include an address-registration function that allows the user to automatically create or update an entry in their address book, calendar, etc.

As yet another example, if the selected information includes a word that is known to be part of an address, the selected information is identified as an address. When the selected information is identified as an address, such as a mailing address, the connection functions can include a map-display function or an address-registration function.

As yet another example, if the selected information is a pattern about time or dates, the connection functions can include a function for providing a service based on time or dates, such as, weather, events, travel, etc. When the selected information is a pattern about a location, the connection functions can include a function for providing a location-based service, such as weather, news, etc.

An aspect of the present disclosure provides a method of providing an additional information service onto an e-mail, which comprises analyzing at least one string included in the content provided to a user terminal for an information pattern, wherein the information pattern is corresponds to one or more connection functions; and providing the analyzed information pattern or the information that indicates the connection functions corresponding to the information pattern to the user, wherein when the user sets a block, selects, or highlights information in the content, a connection function menu is displayed in the user terminal so that the user can select the one or more connection functions.

Another aspect of the present disclosure provides a method of providing an additional information service onto an e-mail, which comprises transmitting selected or highlighted information to a web server when at least a portion of a basic information transmitted from the web server is selected; receiving connection function menu data for executing one or more connection functions according to the pattern of the selected information from the web server; outputting a connection function menu generated using the received connection function menu data; transmitting an execution-request message for the connection function selected by an user on the connection function menu to the web server; and receiving the result of the execution of the selected connection function from the web server to output the result.

Another aspect of the present disclosure provides a system for providing an additional information service onto an e-mail, which comprises a web server that receives a message indicating that at least a portion of predetermined basic information provided to a user terminal has been set by a block, analyzes the pattern of a selected information, determines one or more connection functions according to the analyzed pattern, and transmits connection function menu data to the user client so that an user can select the one or more connection functions, wherein the system provides e-mail to the user terminal connected to the system through the Internet.

### BRIEF DESCRIPTION OF THE DRAWINGS

FIG. 1 illustrates an example of a method of using content of an e-mail in an e-mail service.

FIG. 2 illustrates the configuration of a system for providing an e-mail service that implements additional information service according to an embodiment of the present disclosure.

FIG. 3 is a flowchart illustrating a method of providing an e-mail service according to an embodiment of the present disclosure.

FIG. 4 is a flowchart illustrating a method of providing an e-mail service according to an embodiment of the present disclosure.

FIG. 5 is a block diagram illustrating the configuration of a web server according to an embodiment of the present disclosure.

FIG. 6 illustrates a first example of implementing an e-mail service according to an embodiment of the present disclosure.

FIG. 7 illustrates a second example of implementing an e-mail service according to an embodiment of the present disclosure.

FIG. 8 illustrates a third example of implementing an e-mail service according to an embodiment of the present disclosure.

### DETAILED DESCRIPTION OF SOME EMBODIMENTS

Reference will now be made in detail to exemplary embodiments of the present disclosure, examples of which are illustrated in the accompanying drawings, wherein like reference numerals refer to the like elements throughout. The exemplary embodiments are described below in order to explain the present disclosure by referring to the figures.

Generally, when using e-mail services, a user not only reads the received e-mails, but also sometimes may attach a document or a portion of a document. Typically, the user executes a separate editor program to view the content in the attachment.

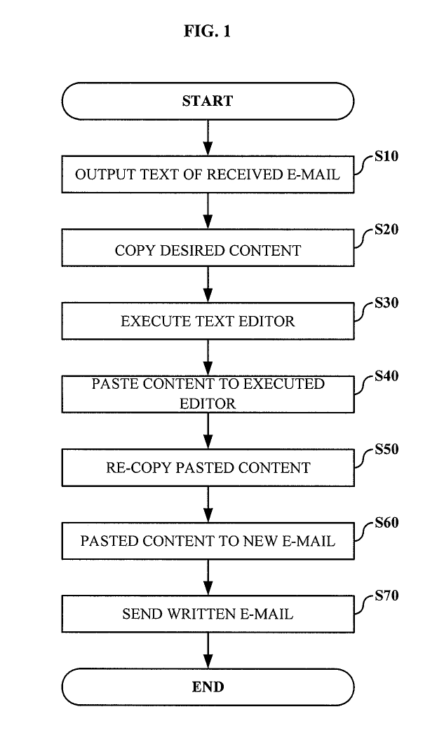

FIG. 1 illustrates an example of a method copying content from an e-mail into a new e-mail. At S10, the user connects to a website that provides the e-mail service, and selects an e-mail.

At S20, the text of the selected e-mail is displayed and the user copies a desired portion of the text. Generally, when copying the content, items such as HTML tags may be copied. At S30, in order to remove the copied HTML tags, the user may execute a text editor, for example, a memo program or word processor installed on the user's terminal. At S40, the copied content without the HTML tags is pasted in a document of the word processor, and thus, the content except HTML tags may be displayed.

At S50, the user copies the content displayed in the word processor wholly or partially, and clicks on the link, such as compose e-mail, or write a new letter, in order to compose a new e-mail service. At S60, the user then pastes the content copied into the new e-mail. At S70, the user composes any remaining portion of the new-email and sends the e-mail to a desired receiver.

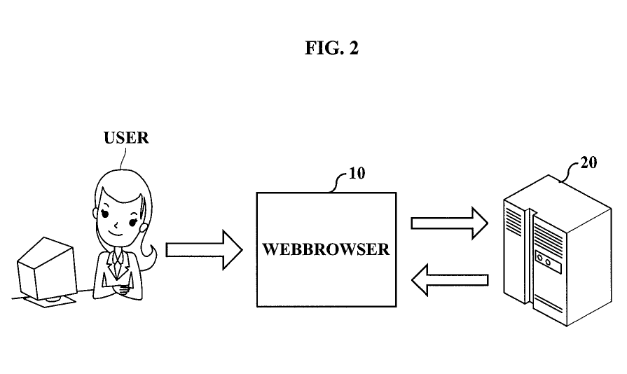

FIG. 2 illustrates the configuration of a system for providing an e-mail service that implements additional information service according to an embodiment of the present disclosure. As shown, the system can include a web browser 10 that is used by a user at their terminal. The web browser 10 may be coupled a web server 20 for example over a network, such as the Internet network. The network may include a wide variety of communication infrastructures, such as a wire/wireless network and a local network.

Web browser 10 may be implemented using well known browsers, such as Internet Explorer by the Microsoft Corporation or Firefox by Mozilla. Web browser 10 may be running on the user's terminal based on a well known computing platform, such as a personal computer, laptop computer, mobile phone, and the like. The user's terminal may also include other components of hardware and software, such as an operating system, a word processor, an e-mail client, other well-known applications, as well as, a mouse, touchpad, keyboard, display, and the like.

Web server 20 provides various services to web browser 10 over a network. Web server 20 may be implemented using well known components of hardware and software. In the embodiments shown, web server 20 may configured to provide web services related to an e-mail service. The web server 20 can include one or more servers for other functions, such as a user authentication server, and an e-mail service server, but the present disclosure is not intended to be limited to these types of servers. The web server 20 may also offload or cooperate with other servers (not shown) in order to perform various functions, such as analysis of selected text. One skilled in the art will recognize that embodiments of the present disclosure may relate to other web services, online services, or network communications.

In generally, the web server 20 communicates data with the web browser 10. For example, the web server 20 may transmit data received from the web browser 10 for an e-mail service implemented through the web browser 10. Also, the web server 20 may provide other information or services, such as providing web documents, web pages, and other types of web applications. An artisan will recognize that the web server 20 and the web browser 10 may employ well known executable program code to support its functions, such as Java, AJAX, ActiveX, and the like.

During operation, the user can interface with the applications provided by the web server 20, such as checking e-mail or reading e-mail through web browser 10. According to the present disclosure, when a user selects a portion of the content of an e-mail, it is possible to execute various connection functions applicable to the portion selected. For example, the user may use a mouse, a keyboard or a touch pad to set a block of, select, or highlight a portion of text, or other items in the e-mail. When the user selects a block of text or selects an object through the use of items, a menu may automatically appear or may appear when requested by the user, such as a right click of a mouse button.

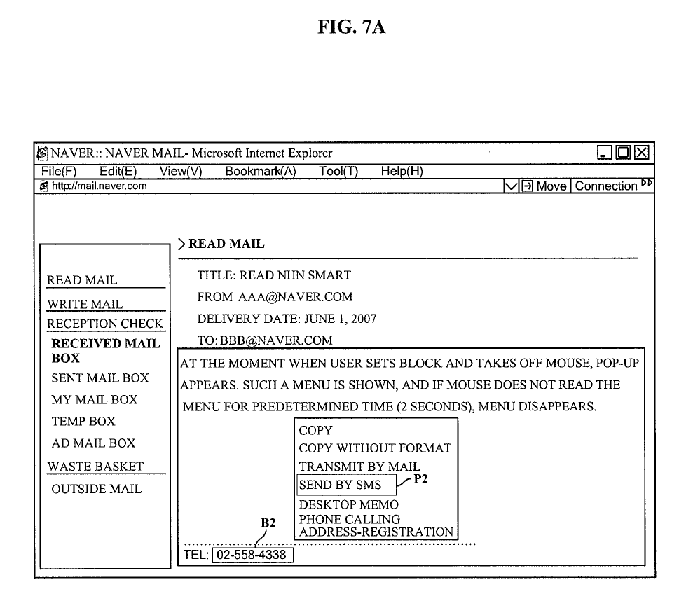

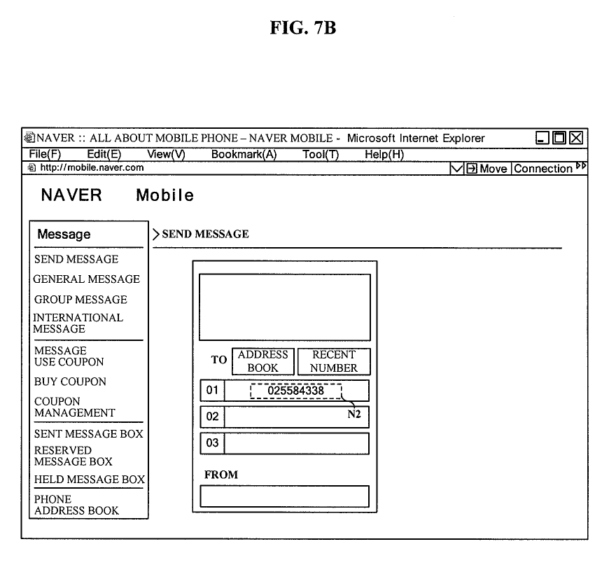

The menu can be controlled such that when the handling of a mouse, a keyboard or a touch pad for setting the block is completed, the menu automatically appears and disappears after a certain period of time so that the user's editing or reading is not interrupted. For example, these menus may be implemented in the form of context menus or right-click menus. Such types of menus are known to those skilled in the art. Of course, other types of menus may be implemented in the embodiments. Examples of novel menus are provided in the present disclosure, an example of which may be found with reference to FIG. 7A.

In an embodiment, the menu provided to the user may comprise various entries that are associated with various executable functions, such as a connection function, as well as other useful features. If the user selects a connection function from the menu, the selection may be indicated to the user. The connection functions can include various functions, such as, send by SMS and copy except the format. Other connection functions that are commonly applicable may be included for the editing convenience or in order to provide other functions regardless of the content of the information within the block selected by the user. In addition, connection functions may be provided that relate to the content of the information within the selected block, such as view the map, register an address, and weather forecast. Of course, one skilled in the art will recognize that a wide variety of connection functions can be provided to the user in the form of menu. Alternatively, in some contexts, there may be relatively fewer connection functions needed, such as when the user terminal is a relatively simple device. In these cases, the connection functions may be directly executed without providing a menu.

Accordingly, embodiments of the present disclosure can provide the user with easy to use functions, such as convenient text-editing and convenient access to additional information that may be related to selected text. One skilled in the art will recognize that various modifications can be implemented in other embodiments.

For embodiments related to e-mail services, the web server 20 can provide the text of a selected e-mail when an e-mail is selected, for example, from the received e-mails, and can analyze a pattern about a string included in the selected text or item by the user. The basic information in an e-mail may be its text as well as its associated meta-data, such as e-mail addresses, details about the protocols used, and the like. The basic information may also comprise information about attachments or data embedded in the e-mail, such as audio, images, video, etc.

When analysis is requested (by the user or by the web browser 10), the web server 20 reads the selected text or item, determines the pattern of the selected text or item, and determines appropriate connection functions corresponding to the pattern. When any one function is selected from the connection function menu, the web server 202 may then provide web page data so that the web page corresponding to the selected function is outputted to the terminal. The selected connection function may also trigger other actions, such as, opening a new browser window to display other content, display of one or more windows, or starting of another application at the terminal.

In order to perform its pattern analysis, web server 20 may request or receive data about the selected text or item from the user. For example, information about the selected text or data may be transmitted in a message to the web server 20. As noted, the selected text or item is not limited to string or text information, but can be extended to images, sound data or multimedia data. In addition, the web server 20 may employ the services of other servers to assist in the analysis of the selected items. For example, the web server 20 may access content from other remote servers on the Internet. In addition, the web server 20 may employ the assistance of other servers within a local network. Accordingly, the web server 20 may utilize a variety of resources, including other servers, to perform its analysis and other functions.

The pattern analysis of the selected text or item may be performed using known algorithms and processes. For example, where the content of an e-mail is “I will go to Seoul on May 23”, and if the user selects “May 23”, web server 20 may recognize that the selection is information corresponding a date. Accordingly, web server 20 may provide connection functions for the related information, such as the weather of the date, information of the day of the week, and a separately-stored schedule to be directly provided to the user.

Further, web server 20 can be modified in various ways. For example, instead of analyzing the pattern selected text after a user selects it, the pattern analysis may be performed in advance on an email even before the user selects or highlights any of the information. Web server 20 may then provide available connection functions (or the result of the pattern analysis) to the user along with the e-mail. Thus, when the user selects text or an item of content of the e-mail, the connection functions can be immediately provided to the user.

For example, if the content of an e-mail is “I will go to Seoul on May 23”, web server 20 may recognize that the pattern of “May 23” is a date. For dates, web server 20 may determine the connection functions in advance for the date are the day of the week, weather and registered schedule. The web server 20 may transmit information and program code about the result of the pattern analysis (or connection function corresponding to the recognized pattern) to the user along with the e-mail. Here, web browser 10 may display connection function information while the user is reading the content of the e-mail even before the user selects text or an item.

Embodiments of the present disclosure may be applicable to any type of application or web application. In order to illustrate various aspects of the embodiments, various flowcharts and screen displays for an e-mail service will now be provided. These examples provided are non-limiting examples and one skilled in the art will recognize how the embodiments may be applicable to other forms of applications.

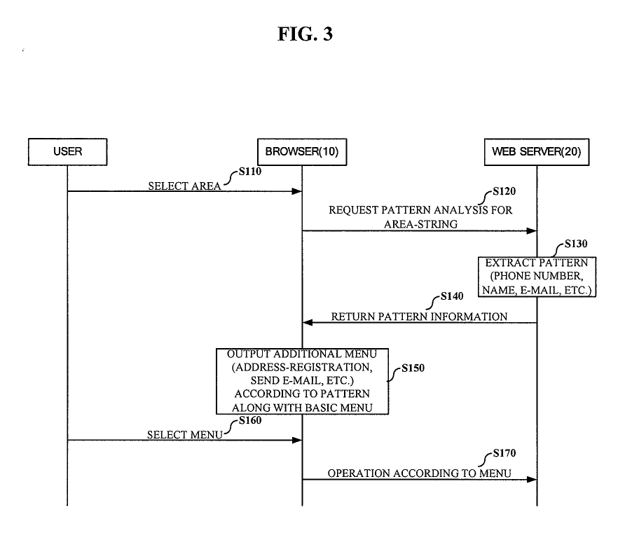

FIG. 3 is a flowchart illustrating a method of providing an e-mail service that implements an additional information service according to an embodiment of the present disclosure. Initially, when a user is connected to web server 20, web server 20 may check whether the user is authentic before providing access to any e-mail service. When it is determined that the user is authentic, the e-mail data is received from the e-mail account, and web server 20 may provide the e-mail service to the user.

In step S100, when the list data of the e-mails received to the e-mail account is transmitted, the browser 10 of the terminal can output the list data, such as a list of received e-mails, as well as other e-mails like sent e-mails, deleted e-mails, etc. Also, when any one of the received e-mails is selected by the user through the use of the input means such as a mouse, a keyboard and a touch pad, a message requesting the selected e-mail letter may be transmitted to the web server 20. The web server 20 may then transmit the data of the text of the selected e-mail to the terminal and data for the e-mail may be displayed on the browser 10.

In step S110, while the text is displayed, a user may set a block of, select, or highlight information in the e-mail. When a selection or highlighting is made by the user, a request message may be sent to the web server 20. The format of the message to analyze the pattern of the selected text or item may be designed in various manners as necessary, and it is possible to include the selected text or item within the message.

In step S120, the web server 20 reads and analyzes the message indicating what was selected or highlighted by the user. Web server 20 may classify the data by predetermined formats or patterns and may provide the information back to the terminal. The information about the format or pattern may be provided in various forms, such as program code like JavaScript, or an executable script, or other formats of data. The selected text or item received in the web server 20 can be in the form of at least one letter, number or a combination of letters and numbers. Any combination of text or data may be analyzed for its format or pattern. Also, the content of the selected text or item may be an image, sound data, or multimedia data.

In step S130, web server 20 generates the pattern information (or connection function menu data) based on the determined pattern or format. Web server 20 may also transmit the pattern or format information back to the terminal. As noted, the web server 20 may transmit this information in a variety of forms and may employ any of a number of types of program code.

In step S140, a predetermined menu (or connection function menu) is set to be outputted around selected text or item. The menu may be output or displayed when the user performs an action, such as a drag by a left button of a mouse or a key button input of a keyboard as the user complete their selection of the desired text or item. For example, this menu may be implemented in the form of a context menu or right-click menu. Of course, other types of menus, such as pop-up menus or windows may be employed. In addition, combinations of menus may be used in the embodiments of the present disclosure.

The displayed menu may display the list of various functions that are used by the users in order to utilize the content of the text of the received e-mail according to the user's style. When the connection function menu data generated in the web server 20 is transmitted to the terminal as pattern or format information, the connection function menu can be implemented based on the transmitted connection function menu data. For example, the menu may add or delete various entries based on the data received from the web server 20.

Such a connection function menu can be implemented in various forms by various technologies on the browser 10, such as a pop-up, a layer and a flash object. In an embodiment, the connection function menu may be displayed at a location and timing that generally does not interfere with the user's editing and considers the user's convenience.

In step S150, a user may select one or more entries from the menu and a message for executing the function selected by the user is transmitted to the web server 20. In step S160, the web server 20 may execute the function corresponding to the selected entry and, for example, may provide the implemented web page data to the terminal so that the function can be executed. Of course, as part of the selected entry, other functions may be executed locally on the user's terminal. In an embodiment, if no selection by the user is made for a certain period of time, the connection function menu data may be configured to disappear or fade. For example, if a mouse point or a cursor is not made by the user to the connection function menu after a certain amount of time, such as about two seconds, the menu may disappear or fade.

The connection functions provided in the menu can vary depending on the type of the information in the selected or highlighted block made by the user. The functions can be roughly divided into functions that are executable in the user's terminal and functions where the functions are usually executed in the web server 20. The results of any connection functions may be outputted in the user's terminal, but the present disclosure is not limited by the features of the connection functions.

If desired, the menu may be omitted and the connection function according to the pattern analysis can be directly provided to the user, or automatically executed. For example, if the selected text includes the name of a geographic region, it is possible that the map of the region may be automatically displayed to the user.

The pattern analysis of the embodiments will now be described in further detail. For ASCII text, a web server 20 may read the selection, separate the string data, and read ASCII code of each letter that constitutes the selection or highlighting. Likewise, web server 20 may be configured to analyze letters of different languages, such as Korean alphabet, English alphabet and Chinese characters.

For names of persons, places, or things, the web server 20 may identify an address of the region, the e-mail address, the date, the phone number according to content frequently utilized in this type of information. Connection functions for these patterns may be functions, such as the accessing an address list, a SMS, starting a memo or document, and accessing a schedule separate from or linked with the e-mail service in the web server 20.

For example, for the Korean alphabet or Chinese character, when the selection comprises three to four letters, the string can be considered name data, and can be classified as being a name format or pattern. In the case, there can be various functions provided depending on the sender of the received e-mail. For example, if one or two sets of space are included within the string, it can be determined whether the adjacent string exempting the included space consists of two to four strings, and if the string consists of English alphabets, the string can be classified as name pattern by checking whether the first letter is a capital letter centering on the included space.

For numbers, the selection may be classified according to known formats or patterns of number, such as a phone number. For example, a general type of phone number may include an area code and the telephone exchange number, and sometimes the country code. A mobile phone number may include a set of numbers, assigned to each mobile telephone company to provide mobile telephone service, for example, 011, 016, or 010, followed by a set of numbers. Herein, the phone number or the mobile phone number may be distinguished by hyphens (-) or space. Even if special characters such as space or hyphens are included, the string may be classified as a phone number, if the string consists of consecutive numbers, for example, seven to nine numbers exempting such special characters.

For a combination of multiple letters and numbers, the selection can be classified as an address pattern by checking, for example, whether certain keywords like “street”, “avenue”, etc. is included in the string, and in the case of a multiple of numbers included in the string, the string can be classified as the address pattern even if there is a special character such as a hyphen. In the embodiments, different types of addresses may be recognizable based on their format or patterns. For example, if the string includes “@” in the middle, and at least one “.” after “@”, the string can be classified as an e-mail address.

Furthermore, selections may be identified by referencing a database that includes a set of strings corresponding to some patterns that have been classified in advance. For example, a database may include well known location strings, such as Deachi-dong, Samsung-dong and Yeoksam-dong for the address category. For selections involving a location or an address, location or position-based services can be provided as a connection function back to the web-browser as an entry in the connection function menu. For example, when the selection includes Daechi-dong, the connection function may be a function, such as the map or the traffic situation at that location.

When the selection includes text or an item about time or dates, web server 20 may provide information related with the time or date as a connection function. For example, if the selected text was “mountain climbing on May 20”, web server 20 may provide the weather forecast for May 20 as a connection function in a menu.

Of course, a selection of text or an item may comprise multiple formats or patterns alone or in combination. Accordingly, one skilled in the art will recognize that the embodiments can be useful because the selecting an appropriate connection function becomes very simple.

As described above, various examples and modifications are possible, so the present disclosure is not limited to the above-described information patterns of the strings and the classification methods, and they can be implemented in various manners depending on the user's style, the data types and the method of analyzing the information.

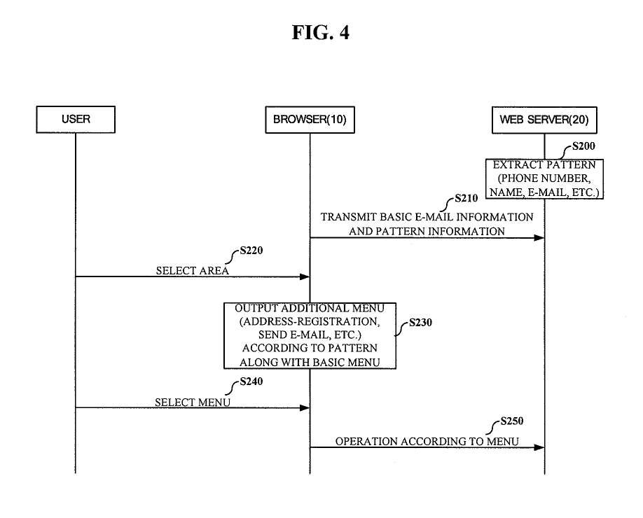

FIG. 4 is a flowchart illustrating another method of providing an e-mail service that implements an additional information service according to an embodiment of the present disclosure. In step S200, the web server 20 analyzes the patterns in the content of the e-mail, and transmits available connection functions (or the result of the pattern analysis) to the user along with the basic information (such as the text content of the e-mail). In an embodiment, it is possible to store the result of the pattern analysis in the web server 20, and transmit the analyzed pattern information or the connection function information to the user only when the user selects or highlights text or an item in the e-mail. Even though the pattern information or the connection function information may be transmitted along with the basic information of the e-mail, the menu may be configured in such a manner that the information is displayed on the screen only after the user has completed selecting or highlighting text or an item.

In steps S220 and S230, the user selects or highlights content of an e-mail, and a connection function menu that lists basic functions, such as cut, copy, and paste, and additional functions can be displayed on the screen of the terminal outside or within browser 10. In step S240, the user selects a connection function, for example, using a keyboard, touchpad, or mouse. In step S250, the connection function is then performed by web server 20 and browser 10. Such a process is similar to that of the embodiment of FIG. 3, so the detailed description is thus omitted here.

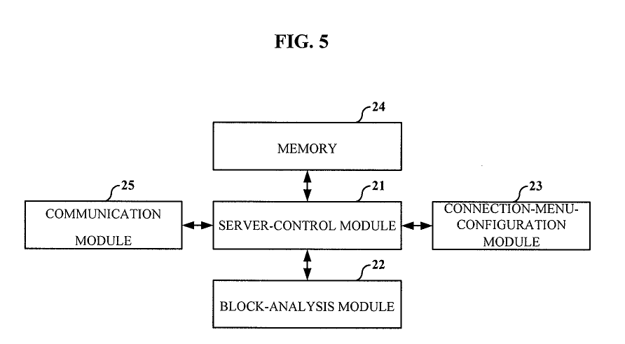

FIG. 5 is a block diagram illustrating an exemplary configuration of the web server 20 included in a system for providing an additional information service according to an embodiment of the present disclosure. As shown, the web server 20 may include a server-control module 21, a block-analysis module 22, a connection-menu-configuration module 23, a memory 24 and a communication module 25. These components may be implemented using components of hardware and software. For example, these components may be implemented by software or program code executing on a processor. In addition, these components may be implemented by various processors or other servers that are operating in conjunction with each other. Such configurations may be known to those skilled in the art.

The server-control module 21 controls general operations of each module 22-25 within the server; reads a message to request pattern analysis from a terminal; and transmits string data included in the message to the block-analysis module 22. Also, the server-control module 21 provides the connection function menu according to the classified pattern, and generates connection function menu data to output the connection function data on the browser 10 of the terminal in a predetermined form.

The block-analysis module 22 analyzes the data, such as string or text data, transmitted from the server-control module 21, and data exempting unnecessary special characters, such as spaces. Control module 21 may classify a certain pattern depending on the pattern types set in advance. For example, some special characters such as “@” may be necessary for determining the e-mail address pattern, so it may be desirable for such characters not to be exempted.

The connection-menu-configuration module 23 generates connection function menu data appropriate for the pattern of the selected text or item, and outputs the connection function menu. As described above, the functions included in the connection function menu can be divided into basic functions that are mainly used by users when a portion of a web document of the text of an e-mail are selected, and additional functions that are based on the pattern of the selection. Further, the menu data can be outputted in various forms, as described above.

The memory 24 stores a control program for controlling operation of each module in the server-control module 21, or user data for connecting to a web server 20, and receiving services. The memory 24 may also store web page data for providing various services to the user. Further, the types of the pattern to be classified or executable connection function list data corresponding to each pattern may be stored in memory 24.

The communication module 25 converts transmitted data in order to meet the communication standards so that the data can be transmitted to and received from the terminal over a network, such as the Internet. Communication module 25 may also convert data in such a manner that the data can be readable in the server-control module 21.

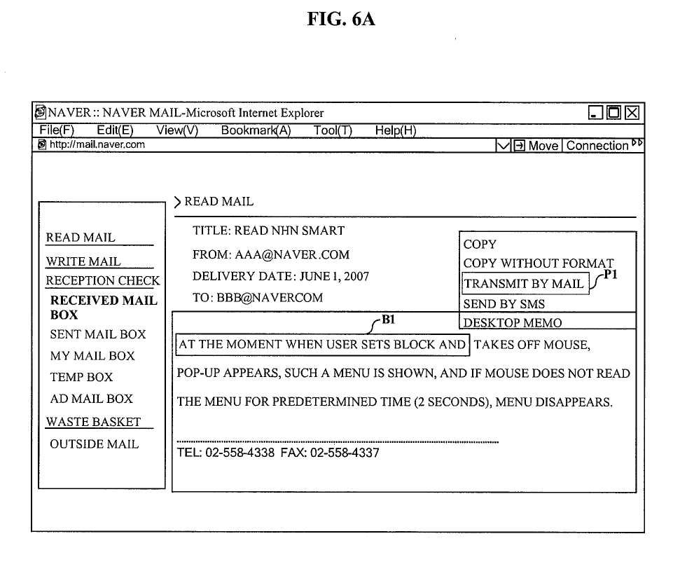

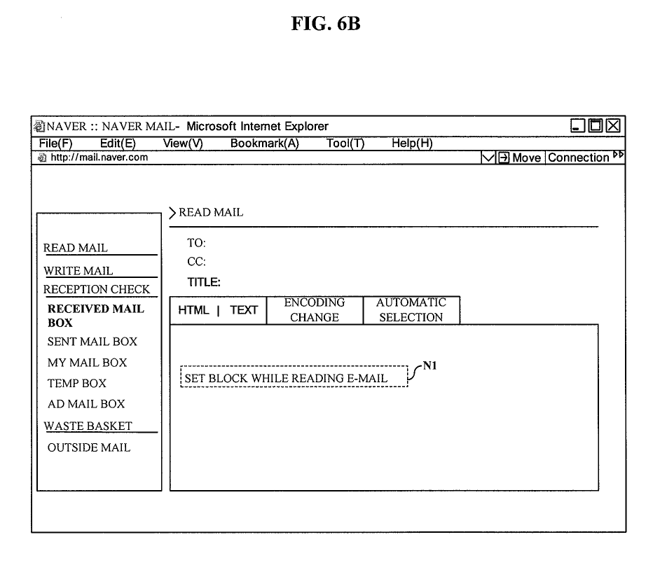

FIG. 6 illustrates a first example of implementing an e-mail service that implements an additional information service according to an embodiment of the present disclosure, FIG. 6A illustrates the selection of text or an item in a received e-mail, and a connection function menu outputted accordingly. FIG. 6B illustrates the function executed when the menu transfer by e-mail is selected.

As illustrated in FIG. 6A, if a portion of the text of an e-mail outputted on the browser 10 of a terminal is selected or highlighted, e.g. block (B1), data included in the block is transmitted to the web server 20, and the pattern corresponding to the data this selected block B1 is analyzed.

As a result of the analysis, if the transmitted data does not constitute a certain pattern, and does not belong to a certain pattern, connection function menu data is generated so that the menu is constituted by basic connection functions, and the data is transmitted to the browser 10. The browser 10 of the terminal receives the data, and outputs them as the connection function menu (P1) around the string set by the block.

Here, the basic connection function menu (P1) may include a copy function, a copy function except the format, a transmission function by an e-mail, a send function by SMS, or a desk top memo function. As shown in FIG. 6B, when the function transfer by e-mail is selected, a web page including an editor for writing an e-mail may be automatically provided. Here, the content set by the block (N1) is set to be included within the e-mail-writing editor.

FIG. 7 illustrates a second example of implementing an e-mail service that implements an additional information service according to an embodiment of the present disclosure, FIG. 7A illustrates a connection function menu outputted when a string corresponding to a phone number pattern is selected from the text of a received e-mail, and FIG. 7B illustrates a function executed when the function send by SMS is selected from the connection function menu outputted in FIG. 7A.

As illustrated in FIG. 7A, if a string consisting of a multiple of numbers is selected, e.g., block (B2) from the text of an outputted e-mail, a web server 20 analyzes the data in the selected block B2. If the data is classified as a phone number pattern, connection function menu data for constituting a connection function menu including address registration, sending by SMS or phone calling function is generated and transmitted to the browser 10. The browser can output the connection function menu (P2) according to the phone number pattern depending on the connection function menu data received from the web server 20.

Further, when the function send by SMS is selected from the outputted connection function menu (P2), as illustrated in FIG. 7B, a web page implemented to send a text message is provided. Here, a phone number set by the block (N2) is automatically inputted in the text-message-sending window included in the web page.

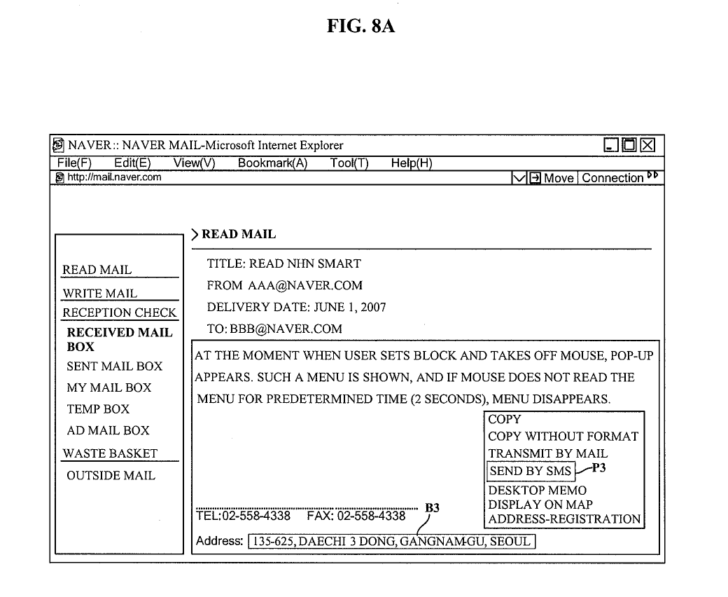

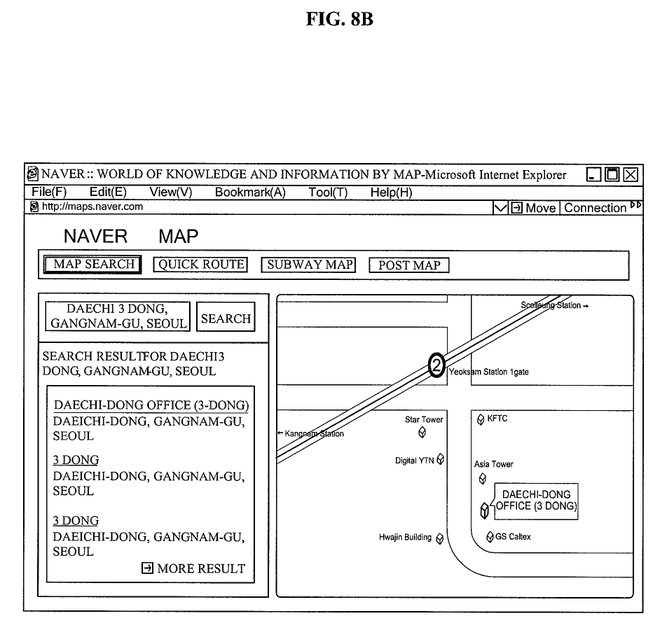

FIG. 8 illustrates another example of implementing an e-mail service that implements an additional information service according to an embodiment of the present disclosure, FIG. 8A illustrates a connection function menu outputted when a string of an address pattern consisting of a multiple of letters and numbers is selected from the text of a received e-mail, and FIG. 8B illustrates a function executed when the function display on the map is selected from the connection function menu outputted in FIG. 8A.

As illustrated in FIG. 8A, when the string consisting of a multiple of letters and numbers are selected, e.g., block (B3) from the text of an outputted e-mail, if the data included in the block is considered to have an address pattern, a web server 20 generates connection function menu data including displaying on a map and address list registration and transmits this information to the browser 10 and may also transmit other basic connection functions. The browser 10 can implement connection function menu P3 according to the address pattern depending on the connection function menu data received from the web server 20, and output the menu around the selected block B3.

Further, if the function display on the map is selected from the outputted connection function menu (P3), a web page for searching the map is provided as illustrated FIG. 8B. Here, the address set by the block is automatically inputted (N3) in the map-search window included in the web page, and the web page is outputted in the state where the corresponding position is indicated on the map.

The accompanying drawings and the detailed description are to only describe embodiments of the present disclosure, and the scope of the present disclosure is not limited thereto. Therefore, those who skilled in the art will understand that many changes and equivalent embodiments can be made without departing from the spirit and aspect of the present disclosure. Thus, the scope of the present disclosure is be determined by the accompanying claims.

According to the present disclosure, if a user selects text or an item in order to utilize a portion of the content of a receive e-mail, the user can quickly perform desired work by analyzing the pattern selected information and providing a connection function.

Also, according to the present disclosure, if a user selects text or an item in the content of an e-mail, the pattern of the selected information is analyzed, one or more connection functions to be considered useful to the user are provided through a menu, and the user can promptly perform desired work by selecting a function.

Also, according to the present disclosure, an e-mail service of a new concept is suggested, so a user can quickly obtain not only the directly-provided basic information through the e-mail service, but also related other useful additional information by the minimum operation or processes.

Also, according to the present disclosure, the efficiency of resources increases so that computer resources or network resources can be used for other works by minimizing the several steps that have been required in utilizing the content of the receive e-mail.

Also, according to the present disclosure, a user can quickly and conveniently perform desired work and decode information by integrally providing the pattern of the selected information and the related additional useful information along with the basic editing function that minimizes steps that have been required in utilizing the content of a received e-mail.

Although a few exemplary embodiments of the present disclosure have been shown and described, the present disclosure is not limited to the described exemplary embodiments. Instead, it would be appreciated by those skilled in the art that changes may be made to these exemplary embodiments without departing from the principles and spirit of the disclosure, the scope of which is defined by the claims and their equivalents.

What is claimed is:

1. A method of serving a web application to an application running on a user terminal, said method comprising:
receiving, at a server serving the web application, information indicating items selected by a user operation;
identifying, at the server, a format of the items selected; and
providing, to the user terminal, information indicating at least one entry for a context menu for the web application to be displayed at the user terminal based on the identified format of the selected items, wherein the context menu comprises a set of entries corresponding to one or more executable functions.

2. The method of claim 1, wherein providing information for the context menu comprises providing information for the context menu of an e-mail web application.

3. The method of claim 1, wherein receiving information indicating items selected by the user operation comprises receiving information indicating items selected by user operation of a mouse.

4. The method of claim 1, wherein providing at least one entry for the context menu comprises an entry for composing a new e-mail, wherein the new e-mail automatically includes the selected items.

5. The method of claim 1, wherein providing at least one entry for the context menu comprises an entry for transmitting a text message to a mobile device, wherein the new text message automatically includes the selected items.

6. The method of claim 1, wherein providing at least one entry for the context menu comprises an entry for serving content from another server, wherein the content is related to the selected items.

7. The method of claim 6, wherein the entry for content from another server that is related to the selected items comprises comprising an entry for content that is related to at least one of weather, dates, and maps indicated in the selected items.

8. The method of claim 1, wherein providing at least one entry for the context menu comprises an entry for starting an application on the user terminal.

9. The method of claim 1, wherein providing information indicating at least one entry for the context menu comprises providing program code that is executable on the user terminal.

10. The method of claim 1, further comprising:
receiving, at a server serving the web application, information indicating second items selected by the user operation;
identifying, at the server, a format of the second items selected; and
providing, to the user terminal, information that automatically changes the context menu to be displayed at the user terminal based on the format of the second items selected.

11. The method of claim 1, wherein identifying the format of the items selected comprises identifying at least one of a set of predetermined patterns present in the items selected.

12. The method of claim 1, wherein identifying the format of the items selected comprises identifying at least one of a name, a location, an address, a date, and a time present in the items selected.

13. The method of claim 1, wherein identifying the format of the items selected comprises requesting, from at least one additional server, information indicating the format of the items selected.

14. A computer readable medium comprising program code that is executable by at least one server to perform the method of claim 1.

15. A method of interfacing a web application from a user terminal, said method comprising:
detecting, at the user terminal, a user operation selecting items displayed at the user terminal;
sending, to a web server serving the web application, information indicating the selected items;
receiving, from the web server, information that indicates at least one entry in a context menu to be displayed at the user terminal, wherein the at least one entry corresponds to a format of the selected items that is identified by the web server.

16. The method of claim 15, wherein the web application is an e-mail web application.

17. The method of claim 15, wherein detecting the user operation comprises detecting a mouse operation by the user.

18. The method of claim 15, further comprising:
detecting a user selection of at least one of the entries in the context menu; and
providing, to the web server, information indicating the selected at least entry in the context menu.

19. The method of claim 18, further comprising:
receiving, from the web server, additional information indicating execution of the selected at least one entry.

20. The method of claim 15, further comprising:
waiting for a predetermined time for a user selection of at least one entry in the context menu; and
stopping display of the context menu after the predetermined time.

21. The method of claim 15, wherein the context menu is to be displayed as a pop-up menu.

22. The method of claim 15, further comprising:
receiving, at the user terminal, information indicating at least one entry corresponding to formats, identified by the server, in content of the web application before the user has selected items displayed.

23. The method of claim 22, further comprising:
automatically configuring the context menu to be displayed based on the items selected by the user.

24. The method of claim 15, further comprising:
detecting, at the user terminal, a selection by the user of at least one of the entries in the context menu; and
starting another application at the user terminal based on the selection from the context menu.

25. An apparatus comprising means configured to perform the method of claim 15.
